(19) United States
(12) Patent Application Publication
(10) Pub. No.: US 2006/0119592 A1
(43) Pub. Date: Jun. 8, 2006

(54) Electronic device and method of using the same

(76) Inventors: Jian Wang, Goleta, CA (US); Weixiao Zhang, Goleta, CA (US); Gang Yu, Santa Barbara, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/005,065

(22) Filed: Dec. 6, 2004

(51) Int. Cl. G09G 5/00

(52) U.S. Cl. 345/204

(57) ABSTRACT

An electronic device includes a data processing system and a set of pixels that each include one or more radiation-emitting electronic components, one or more radiation-sensing electronic components, or any combination thereof. The data processing system that is configured to access data regarding the set of pixels and determine at least one calibration value corresponding to the data. The number of the calibration value(s) is less than the number of the pixels within the set. The data processing system is further configured to compare the calibration value(s) to another value and change at least one adjustment factor if the calibration value(s) differs from the other value by more than a predetermined amount. The number of the adjustment factor(s) is less than the number of the pixels within the set. Data processing system readable media and methods for using the electronic device are also described.

### BACKGROUND OF THE INVENTION

1. Field of the Invention

This invention relates in general to electronic devices, and more particularly, to electronic devices including radiation-emitting electronic components and methods of using the same.

2. Description of the Related Art

Organic electronic devices have attracted considerable attention in recent years. Examples of organic electronic devices include Organic Light-Emitting Diodes (“OLEDs”), which include Polymer Light-Emitting Diodes (“PLEDs”) and Small Molecule Organic Light-Emitting Diodes (“SMOLEDs”).

Due to a degradation of the radiation-emitting properties of organic electroluminescent materials over the operation lifetime of an OLED, long time operation with a stationary image can result in a burned-in pattern on the display, which reduces display quality considerably. Two approaches can be used to eliminate this image retention: (1) developing new materials and (2) implementing a compensation mechanism for the display panel (e.g., in conjunction with pixel driver circuits for the radiation-emitting electronic components or in peripheral driving electronics to drive each radiation-emitting electronic component) that maintains the display intensity homogeneity over the entire panel area.

PCT Patent Publication Number WO 2004/023443 A2, which is assigned to the current assignee hereof, addresses a driving scheme with radiation intensity compensation to deal with the spatial inhomogeneity (e.g., pixel-to-pixel variation) of a display panel. The driving scheme described in the patent publication may have a relatively high cost, and therefore, may be limited to only certain applications. For many other applications, such a driving scheme may be viewed as too complicated, too costly, or both.

### SUMMARY OF THE INVENTION

A electronic device comprises a set of pixels and a data processing system. The set of pixels each include one or more radiation-emitting components, one or more radiation-sensing components, or any combination thereof. The data processing system that is configured to: access data regarding the set of pixels, wherein the data corresponds to radiation emitted from or sensed by the set of pixels. The data processing system is also configured to determine at least one calibration value corresponding to the data, wherein the number of the calibration value(s) is less than the number of the pixels within the set. The data processing system is further configured to compare the calibration value(s) to another value and change at least one adjustment factor if the calibration value(s) differs from the other value by more than a predetermined amount. The number of the adjustment factor(s) is less than the number of the pixels within the set.

An electronic device includes a dummy display of first radiation-emitting electronic components and a user display of second radiation-emitting electronic components.

A data processing system readable medium has code for using a electronic device. The electronic device includes a set of pixels that each include one or more radiation-emitting electronic components, one or more radiation-sensing electronic components, or any combination thereof. The code is embodied within the data processing system readable medium. The code includes an instruction for accessing data regarding the set of pixels, wherein the data corresponds to radiation emitted from or sensed by the set of pixels. The code also includes an instruction for determining at least one calibration value corresponding to the data. The number of the calibration value(s) is less than the number of the pixels within the set. The code further includes an instruction for comparing the calibration value(s) to another value and an instruction for changing at least one adjustment factor if the calibration value(s) differs from the another value by more than a predetermined amount. The number of the adjustment factor(s) is less than the number of the pixels within the set.

A method of using an electronic device that includes a set of pixels that each include one or more radiation-emitting electronic components, one or more radiation-sensing electronic components, or any combination thereof. If the set of pixels includes radiation-emitting components, the method includes activating the set of pixels and collecting data corresponding to radiation emitted from the set of pixels. Activating the set of pixels and collecting data occur simultaneously during at least one point in time. If the set of pixels includes radiation-sensing components, the method includes activating a radiation source and collecting data using the set of pixels. The set of pixels sense radiation corresponding to the radiation emitted from the radiation source. Activating the radiation source and activating the set of pixels occur simultaneously during at least one point in time. The method further includes determining at least one calibration value corresponding to the collected data, wherein the number of the calibration value(s) is less than the number of the pixels within the set. The method still further includes comparing the calibration value(s) to another value and changing at least one adjustment factor if the calibration value(s) differs from the other value by more than a predetermined amount. The number of the adjustment factor(s) is less than the number of the pixels within the set.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes a plan view of a portion of an electronic device including a user display and a dummy display in accordance with one embodiment.

FIG. 2 includes a plan view of a portion of an electronic device including a user display and a dummy display in accordance with another embodiment.

FIGS. 3 and 4 include illustrations of a plan view and a cross-sectional view, respectively, of portions of an electronic device that comprises an array of pixels, a waveguide, and a radiation-sensing electronic component along an edge of the waveguide.

FIGS. 5 and 6 include illustrations of a plan view and a cross-sectional view, respectively, of portions of an electronic device that comprises an array of pixels, a waveguide, and radiation-sensing electronic components along edges of the waveguide.

FIG. 7 includes an illustration of a cross-sectional view of portions of an array of pixels and a separate radiation-sensing device.

FIG. 8 includes an illustration of a cross-sectional view of portions of an array of pixels, a separate radiation-sensing device, and a waveguide.

FIG. 9 includes an illustration of a cross-sectional view of portions of a waveguide and an electronic device that comprises an array of pixels and photodiodes near the edges of the array.

FIG. 10 includes an illustration of a cross-sectional view of portions of a reflector and an electronic device that comprises an array of pixels and a buried photodetector.

FIG. 11 includes an illustration of a hybrid cross-sectional view of a radiation-sensing apparatus, an electronic device being calibrated, and a process flow chart during a calibration operation.

FIG. 12 includes an illustration of a hybrid cross-sectional view of an electronic device after calibrating and a process flow chart during a normal (e.g., display) operation of the electronic device.

FIG. 13 includes a plot of emission intensity and operation voltage using a conventional constant current driving scheme.

FIG. 14 includes a plot of emission intensity and operation voltage using a method described herein.

FIG. 15 includes a circuit diagram of a pixel driver circuit and a radiation-emitting component.

FIG. 16 includes an illustration of a hybrid cross-sectional view of an electronic device during calibrating and a process flow chart during the calibration operation of the electronic device.

FIG. 17 includes an illustration of a schematic diagram of an electronic device including a data processing system.

FIG. 18 includes a flow diagram for activities that can be carried out by the data processing system of FIG. 17.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

A electronic device includes a set of pixels and a data processing system. The set of pixels each include one or more radiation-emitting components, one or more radiation-sensing components, or any combination thereof. The data processing system that is configured to: access data regarding a set of pixels, wherein the data corresponds to radiation emitted from or sensed by the set of pixels. The data processing system is also configured to determine at least one calibration value corresponding to the data, wherein the number of the calibration value(s) is less than the number of the pixels within the set. The data processing system is further configured to compare the calibration value(s) to another value and change at least one adjustment factor if the calibration value(s) differs from the other value by more than a predetermined amount. The number of the adjustment factor(s) is less than the number of the pixels within the set.

In one embodiment, the set of pixels includes the radiation-emitting component(s). The data processing system comprises a synchronizing unit that controls timing of signals. The signals are used to activate the set of pixels and initiate collection of data corresponding to radiation emitted from the set of pixels. The synchronizing unit is configured such that activation of the set of pixels and collection of the data occur simultaneously during at least one point in time. In a specific embodiment, a second electronic device is configured to collect the data and be coupled to the electronic device, wherein the second electronic device is physically separate from the electronic device. In another specific embodiment, the electronic device further includes at least one radiation-sensing component, wherein the at least one radiation-sensing component is configured to collect the data.

In another embodiment, the set of pixels includes the radiation-sensing component(s). The data processing system comprises a synchronizing unit that controls timing of signals. The signals are used to initiate activation of a radiation source and activate the set of pixels during collecting of the data, which corresponds to radiation emitted from the radiation source. The synchronizing unit is configured such that activation of the radiation source and activation of the set of pixels occur simultaneously during at least one point in time. In one specific embodiment, a second electronic device comprises the radiation source, wherein the second electronic device is physically separate from the electronic device. In another specific embodiment, the electronic further includes the radiation source.

An electronic device includes a dummy display of first radiation-emitting electronic components and a user display of second radiation-emitting electronic components.

In one embodiment, the dummy display is organized into a vector of the first radiation-emitting electronic components, and the user display is organized into a matrix of the second radiation-emitting electronic components. In another embodiment, the dummy display is organized into a matrix of the first radiation-emitting electronic components, and the user display is organized into a matrix of the second radiation-emitting electronic components.

In still another embodiment, the dummy display lies outside the viewing field of the electronic device.

In a further embodiment, the electronic device further includes a radiation-sensing electronic component optically coupled to the dummy display. In a specific embodiment, the radiation-sensing electronic component is part of a calibration circuit. In another specific embodiment, the dummy display and the radiation-sensing electronic component are optically coupled to each other using an optical waveguide. In a further specific embodiment, the dummy display and the radiation-sensing electronic component are optically coupled to each other using a reflector.

A data processing system readable medium has code for using a electronic device. The electronic device includes a set of pixels that each include one or more radiation-emitting electronic components, one or more radiation-sensing electronic components, or any combination thereof. The code is embodied within the data processing system readable medium. The code includes an instruction for accessing data regarding the set of pixels, wherein the data corresponds to radiation emitted from or sensed by the set of pixels. The code also includes an instruction for determining at least one calibration value corresponding to the data. The number of the calibration value(s) is less than the number of the pixels within the set. The code further includes an instruction for comparing the calibration value(s) to another value and an instruction for changing at least one adjustment factor if the calibration value(s) differs from the another value by more than a predetermined amount. The number of the adjustment factor(s) is less than the number of the pixels within the set.

In one embodiment, the code further includes an instruction for multiplying the adjustment factor(s) times a first input signal to obtain a first output signal. In a more specific embodiment, the code further comprises an instruction for amplifying the first output signal to obtain a second output signal.

In one embodiment, the other value is a prior calibration value. In another embodiment, the set of pixels includes a row or a column of pixels within a user display. In another embodiment, the set of pixels includes all pixels within a user display or within a dummy display. In still a further embodiment, an electronic device includes the data processing system readable medium.

A method of using an electronic device that includes a set of pixels that each include one or more radiation-emitting electronic components, one or more radiation-sensing electronic components, or any combination thereof. If the set of pixels includes radiation-emitting components, the method includes activating the set of pixels and collecting data corresponding to radiation emitted from the set of pixels. Activating the set of pixels and collecting data occur simultaneously during at least one point in time. If the set of pixels includes radiation-sensing components, the method includes activating a radiation source and collecting data using the set of pixels. The set of pixels sense radiation corresponding to the radiation emitted from the radiation source. Activating the radiation source and activating the set of pixels occur simultaneously during at least one point in time. The method further includes determining at least one calibration value corresponding to the collected data, wherein the number of the calibration value(s) is less than the number of the pixels within the set. The method still further includes comparing the calibration value(s) to another value and changing at least one adjustment factor if the calibration value(s) differs from the other value by more than a predetermined amount. The number of the adjustment factor(s) is less than the number of the pixels within the set.

In one embodiment, the other value is a prior calibration value.

In another embodiment, the method further includes multiplying the at least one adjustment factor times a first input signal to obtain a first output signal. In a specific embodiment, the method further includes receiving a second input signal and converting the second input signal to the first input signal. In a more specific embodiment, the first input signal is a voltage, and the second input signal is a current. In another specific embodiment, the method includes amplifying the first output signal to obtain a second output signal. In a more specific embodiment, each of the first output signal and the second output signal is a voltage.

In a further embodiment, activating a set of pixels includes activating a row or a column of pixels within a user display. In still a further embodiment, activating a set of pixels includes activating all pixels within a user display. In still a further embodiment, activating a set of pixels includes activating all pixels within a dummy display.

In any of the embodiments described herein, the radiation-emitting electronic components whether within the user display, dummy display, or both include at least one organic active layer.

The detailed description first addresses Definitions and Clarification of Terms followed by Electronic Device Structures and Radiation Sensing During Calibration, Methods of Using the Electronic Devices During Calibration and Normal Operating Modes, Other Embodiments, Advantages, and finally Examples.

1. Definitions and Clarification of Terms

Before addressing details of embodiments described below, some terms are defined or clarified. As used herein, the term “activating,” when referring to a radiation-emitting electronic component, is intended to mean providing proper signal(s) to the radiation-emitting electronic component so that radiation at a desired wavelength or spectrum of wavelengths is emitted.

The term “adjustment factor” is intended to mean a factor applied to a signal going to or coming from an array of electronic components to compensate for the aging or degradation of materials within an electronic device.

The terms “array,” “peripheral circuitry” and “remote circuitry” are intended to mean different areas or components. For example, an array may include a number of pixels, cells, or other electronic devices within an orderly arrangement (usually designated by columns and rows) within a component. These electronic devices may be controlled locally on the component by peripheral circuitry, which may lie within the same component as the array but outside the array itself. Examples of peripheral circuits include column or row decoders, column or row array strobes, or the like. Remote circuitry typically lies within a different component and can send signals to or receive signals from the array (typically via the peripheral circuitry).

The terms “calibration value” is intended to mean a value obtained during a calibration procedure that is reflective of the then-current state (i.e., when the calibration procedure is performed) of a system or a portion thereof.

The terms “code” is intended to mean a set of symbols for representing one or more instructions that currently can or be compiled into a form that can be executed by a machine, such as a computer. Source code, object code, and assembly code are examples of different types of code.

The terms “data processing system” is intended to mean one or more components that are configured to process data input in the form of signals (e.g., electronic, electrical, mechanical, electromechanical, radiation (e.g., optical, microwave, etc.), or any combination thereof. A data processing system can be a standalone unit (e.g., a personal computer) or a subassembly within a larger system (e.g., a mobile phone).

The terms “data processing system readable medium” is intended to mean a medium that can be read by a data processing system. A computer readable medium is an example of a data processing system readable medium. An example of a data processing system readable medium includes a read-only memory (“ROM”), a random-access memory (“RAM”), a hard disk (“HD”), a database, a storage area network system (“SANS”) array, magnetic tape, floppy diskette, optical storage device, CD ROM, or any combination thereof.

The term “dummy display” is intended to mean a set of pixels including at least one radiation-emitting electronic component, wherein the dummy display lies within the electronic device but outside of a user display. The radiation-emitting electronic component(s) of the dummy display may only be used during a calibration procedure, lie outside the viewing field of an electronic device, or a combination thereof (used during a calibration procedure and lies outside the viewing field).

The term “electronic component” is intended to mean a lowest level unit of a circuit that performs an electrical function. An electronic component may include a transistor, a diode, a resistor, a capacitor, an inductor, or the like. An electronic component does not include parasitic resistance (e.g., resistance of a wire) or parasitic capacitance (e.g., capacitive coupling between two conductors connected to different electronic components where a capacitor between the conductors is unintended or incidental).

The term “electronic device” is intended to mean a collection of circuits, organic electronic components, or combinations thereof that collectively, when properly connected and supplied with the proper potential(s), performs a function. An electronic device may include or be part of a system. Examples of electronic devices include displays, sensor arrays, computer systems, avionics, automobiles, cellular phones, and many other consumer and industrial electronic products.

The term “matrix” is intended to mean an organization of electronic components extending in two directions. A matrix can include at least two rows and at least two columns.

The term “optically coupled” is intended to mean a connection, linking, or association of two or more electronic components, circuits, or systems in such a way that an optical signal may be transferred from one electronic component(s), circuit(s), or system(s) to another electronic component(s), circuit(s), or system(s).

The term “organic active layer” is intended to mean one or more organic layers, wherein at least one of the organic layers, by itself, or when in contact with a dissimilar material is capable of forming a rectifying junction.

The term “organic electronic device” is intended to mean a device including one or more organic semiconductor layers or materials. Organic electronic devices include: (1) devices that convert electrical energy into radiation (e.g., a light-emitting diode, light-emitting diode display, diode laser, or lighting panel), (2) devices that detect signals through electronic processes (e.g., photodetectors (e.g., photoconductive cells, photoresistors, photoswitches, phototransistors, phototubes), infrared (“IR”) detectors, biosensors), (3) devices that convert radiation into electrical energy (e.g., a photovoltaic device or solar cell), and (4) devices that include one or more electronic components that include one or more organic semiconductor layers (e.g., a transistor or diode).

The term “pixel” is intended to mean the smallest complete unit of a display or sensor. A pixel may include one or more radiation-emitting or radiation-sensing electronic components. In a full-color display, a full-color pixel may include three radiation-emitting electronic components that correspond to red, green, and blue spectral regions. For a monochromatic display, a pixel may include only one radiation-emitting electronic component.

The term “physically separate” is intended to mean two or more objects do not touch one another or can be disconnected from one another without substantially affecting functionality of each of the objects. For example, a camera can be connected to a data processing system using a wire or cable when images are being downloaded. However, the camera and data processing system can be disconnected, and the camera still will be able to capture images, and the data processing system can process data (e.g., manipulate the images transferred from the camera).

The term “radiation-emitting component” is intended to mean an electronic component, which when properly biased, emits radiation at a targeted wavelength or spectrum of wavelengths. The radiation may be within the visible-light spectrum, outside the visible-light spectrum (ultraviolet (“UV”) or IR), or both. A light-emitting diode is an example of a radiation-emitting component.

The term “radiation-sensing component” is intended to mean an electronic component, which when properly biased, can sense radiation at a targeted wavelength or spectrum of wavelengths. The radiation may be within the visible-light spectrum, outside the visible-light spectrum (UV or IR), or both. IR sensor is an example of a radiation-sensing component.

The term “rectifying junction” is intended to mean a junction within semiconductor layer or a junction formed by an interface between a semiconductor layer and a dissimilar material in which charge carriers of one type flow easier in one direction through the junction compare to the opposition direction. A pn junction is an example of a rectifying junction that can be used as a diode.

The term “reflector” is intended to mean a layer, member, structure, or a combination thereof having a principal function of redirecting radiation. A mirror is an example of a reflector.

The term “signal” is intended to mean a current or a voltage. The signal can be a voltage or current from a power supply or can represent, by itself or in combination with other signal(s), data or other information. Signals may be substantially constant (e.g., power supply voltages) or may vary over time (e.g., one voltage for on and another voltage for off).

The term “state” is intended to refer to information used for calibration factors at a point in time. For example, the first time an electronic device is calibrated may be an initial state. The second time the electronic device is calibrated may be the most recent state until the next calibration, and the initial state is now the prior state. A third calibration may include data collected for a most recent state, and information collected during the second calibration may now be the prior state.

The terms “synchronizing unit” is intended to mean a circuit, system, or subsystem that coordinates timing between two or more components, circuits, systems, or subsystems. The two or more components, circuits, systems, or subsystems and the synchronizing unit may reside within a single electronic device or within nearly any number of electronic devices.

The term “user display” is intended to mean radiation-emitting electronic components of a display or portion thereof that can be seen by a user of an electronic device.

The term “user side” of an electronic device refers to a side of the electronic device adjacent to a transparent electrode and principally used during normal operation of the electronic device. In the case of a display, the side of the electronic device having the display would be a user side. In the case of a detector or photovoltaic cell, the user side would be the side that principally receives radiation that is to be detected or converted to electrical energy.

The term “vector” is intended to mean an organization of electronic components along a line or line segment. For example, a vector of electronic components may lie along a row, a column, a diagonal, or the like.

The term “viewing field” is intended to mean any portion of an electronic device that is seen by a user during normal operation of the electronic device. The viewing field does not include a portion of the electronic device that would otherwise be seen when the electronic device is disassembled or during a maintenance, calibration, or other similar procedure.

The term “waveguide” is intended to mean a layer, member, or structure wherein at least a significant portion of radiation is transmitted along the layer, member, or structure. A waveguide effect can occur when a material of a higher refractive index is surrounded by a material of lower refractive index. For the purposes of this specification, the waveguide may include (1) the material of the higher refractive index by itself, when such material of higher refractive contacts and is surrounded by a fluid having a lower refractive index or (2) a combination of the materials of higher and lower refractive index when the material of the lower refractive index is a solid. An optical waveguide is an example of a waveguide that can be used for transmitting radiation within the visible light spectrum.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Group numbers corresponding to columns within the periodic table of the elements use the “New Notation” convention as seen in the CRC Handbook of Chemistry and Physics, 81^{st} Edition (2000).

To the extent not described herein, many details regarding specific materials, processing acts, and circuits are conventional and may be found in textbooks and other sources within the organic light-emitting display, photodetector, semiconductor and microelectronic circuit arts. Details regarding radiation-emitting elements, pixels, subpixels, and pixel and subpixel circuitry will be addressed before turning to details of the radiation-sensing elements and circuitry.

2. Electronic Device Structures and Radiation Sensing During Calibration

Embodiments illustrated in the figures and described below can be used to collect data during emission that can be used to generate adjustment factor(s) to compensate for degradation, aging, or both of radiation-emitting electronic components within an array. In one embodiment, data can be collected for an entire array of radiation-emitting electronic components to provide a single adjustment factor for the array. In another embodiment, data can be collected for a row, a column or other portion of the array (e.g., a quadrant) to provide a single calibration value for each row, column or other portion of the array. More or fewer adjustment factors can be used. In one embodiment, the number of adjustment factors is less than the number of pixels within an array. As will be described later, the concepts can potentially be extended to other types of electronic components, such as radiation-sensitive electronic components.

FIG. 1 includes an illustration of a plan view of an electronic device 100 that includes a user display 120, a dummy display 162, and a radiation-sensing electronic component 164. When radiation is emitted from the dummy display 162, it can be sensed by the radiation-sensing electronic component 164.

The dummy display 162 includes a plurality of radiation-emitting electronic components. In one embodiment, the user display 120 and dummy display 162 have the same type of radiation-emitting electronic components, and in another embodiment, the user display 120 and dummy display 162 have at least on different type of radiation-emitting electronic components. In one specific embodiment, the user display 120 is a full color, active matrix OLED (“AMOLED”) display that includes red, green, and blue radiation-emitting electronic components, and the dummy display 162 includes any one or more of red, green, or blue radiation-emitting electronic components. In another embodiment, the user display 120 includes white radiation-emitting electronic components, and the dummy display 162 includes any one or more of red, green, or blue radiation-emitting electronic components. In still another embodiment, the user display 120 includes red, green, and blue radiation-emitting electronic components, and the dummy display 162 includes white radiation-emitting electronic components. In yet a further embodiment, the user display 120, dummy display 162, or both are monochromatic and have only one type of radiation-emitting electronic component.

In one embodiment, the radiation-sensing electronic component 164 is a single radiation-sensing electronic component, and in another embodiment, a plurality of radiation-sensing electronic components 164 is used. The plurality of radiation-sensing electronic components 164 may be of the same or different types (e.g., one more sensitive to green-to-blue radiation, and another more sensitive to yellow-to-red radiation).

As illustrated in FIG. 1, solid line 140 corresponds to an edge of a viewing field 122 for the user display 120. A user of the electronic device 100 can see the portion of the display corresponding to the viewing field 122, but cannot see other parts of the user display 120, the dummy display 162, or the radiation-sensing electronic component 164. For example, a housing for the electronic device 100 may cover portions of the user display 120, the dummy display 162, and the radiation-sensing electronic component 164. In another embodiment (not shown), all of the user display 120, dummy display 162, radiation-sensing electronic component 164, or any combination thereof lie within the viewing field 122.

In the embodiment as illustrated in FIG. 1, each of the dummy display 162 and radiation-sensing electronic component 164 has a length that corresponds to the width of the viewing field 122. In another embodiment, each of the dummy display 162 and radiation-sensing electronic component 164 has a length that corresponds to the width of the user display 120. In still another embodiment, each of the dummy display 162 and radiation-sensing electronic component 164 has a length that is narrower than the width of the viewing field 122. In yet another embodiment, dummy display 162 and radiation-sensing electronic component 164 are oriented along the length of the viewing field 122. In yet a further embodiment, each of the dummy display 162 and radiation-sensing electronic component 164 has a length that is wider than the corresponding edge of the viewing field 122 along which it resides.

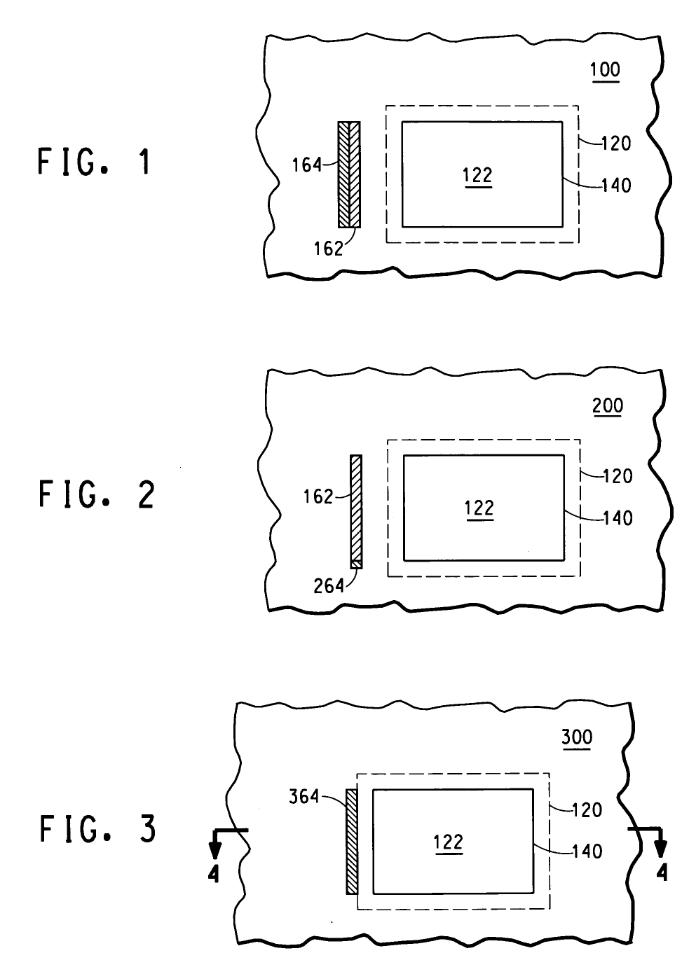

FIG. 2 includes a plan view of an electronic device 200 similar to the electronic device 100. However, the radiation-sensing electronic component 264 is optically coupled to the width, rather than the length (in FIG. 1), of a dummy display 162. The size and orientation of the dummy display 162 and the radiation-sensing electronic component 164 with respect to the user display 120, viewing field 122, or both with respect to electronic device 100 may also be used for display 162 and the radiation-sensing electronic component 264 of the electronic device 200. Also, the number of electronic components and any of the combinations of electronic components with respect to the radiation-sensing electronic component 164 can also be used for the radiation-sensing electronic component 264.

FIG. 3 includes a plan view of an electronic device 300 in which a radiation-sensing electronic component 364 lies along a side of the user display 120. In one embodiment (as illustrated in FIG. 3), the radiation-sensing electronic component 364 lies along the width of the user display 120. In another embodiment (not shown), the radiation-sensing electronic component 364 lies along the length of the user display 120. The size and orientation of the radiation-sensing electronic component 164 with respect to the electronic device 100 in FIG. 1 may also be used for the radiation-sensing electronic component 364 of the electronic device 300. Also, the number of electronic components and any of the combinations of electronic components with respect to the radiation-sensing electronic component 164 can also be used for the radiation-sensing electronic component 364.

FIG. 4 includes an illustration of a cross-sectional view of the electronic device 300. The electronic device 300 can include a passivation layer or protective shield 402 and an array that is oriented in rows and columns of pixels 404 that extend to edges 406 of the array. Each pixel has at least one radiation-emitting electronic component that emits radiation 408 (illustrated by arrows). In one embodiment, a full color pixel includes a red radiation-emitting electronic component, a green radiation-emitting electronic component, and a blue radiation-emitting electronic component. In another embodiment, each pixel includes a white radiation-emitting electronic component. The protective shield 402 can protect the pixels 404 and other electronic circuits, if any, from environmental hazards or other conditions (e.g., scratches, moisture, mobile ions, other contamination, or the like). The electronic device 300 may have a modified substrate 405, wherein a portion of the substrate can act as a waveguide 440. The radiation-sensing electronic component 364 may lie within the substrate 405. A combination of the substrate 405 and air on the user side 320 of the electronic device 300 can act as a waveguide.

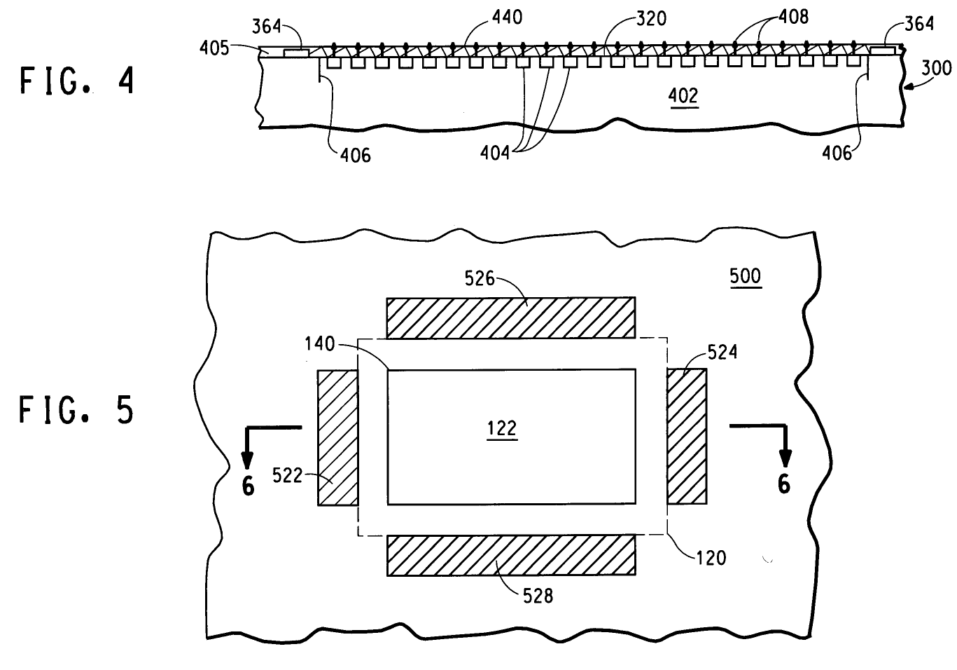

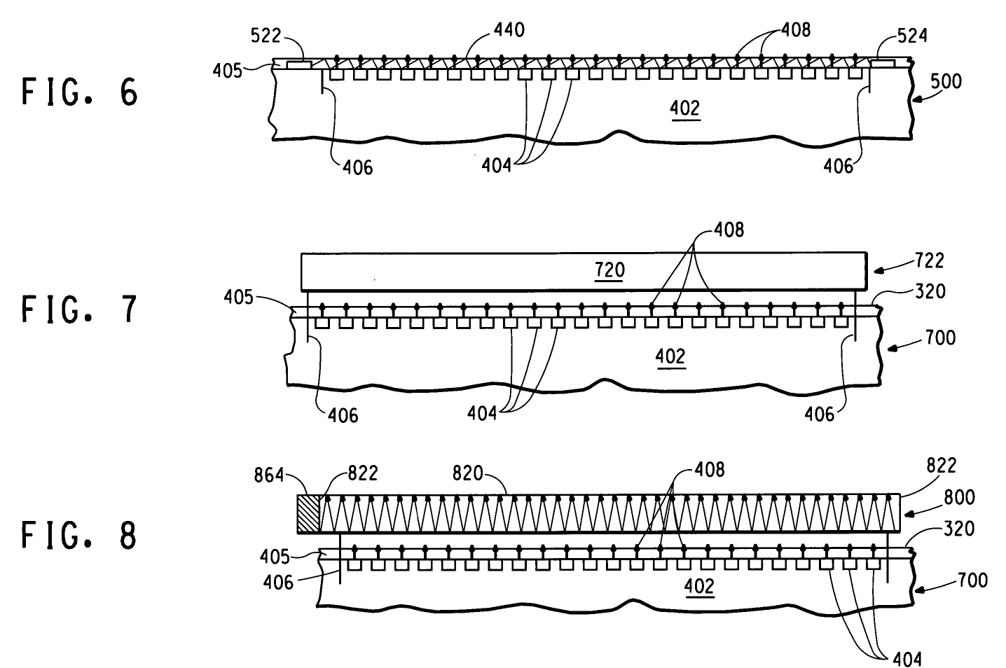

FIGS. 5 and 6 include an alternative embodiment similar to FIGS. 3 and 4 except that the electronic device 500 includes a plurality of radiation-sensing electronic components 522, 524, 526, and 528 along different edges of the user display 120. During a normal (e.g., display) operation, a plurality of pixels 404 may have radiation 408 emitted that passes through the substrate 405 and waveguide 440.

FIGS. 1-6 illustrate embodiments in which radiation-sensing electronic components can be used during a calibration operation without the need of any separate or other external radiation sensors, radiation reflectors (e.g., mirrors), or the like. FIGS. 7-10 illustrate embodiments of electronic devices in which a separate or other external radiation sensor, an external radiation reflector, or both can be used.

FIG. 7 includes an illustration of a cross-sectional view of a calibrating system that includes an electronic device 700 and a separate radiation-sensing device 720. Each of the pixels 404 can emit radiation as illustrated by arrows 408 in FIG. 7. The radiation-sensing device 720 may be placed in contact with or otherwise adjacent to the user side 320. Notice that the radiation-sensing device 720 may be the same size or larger than the array because its edges 722 extend beyond the edges 406 of the array. The radiation-sensing device 720 may be a conventional photodiode or photosensitive transistor that may include a p-n junction. Although not shown, electrical connections and a sense amplifier may be connected to the photodiode or photosensitive transistor. During calibration, some or all of pixels 404 within the array may be activated at the same time while their emission intensity is measured by the radiation-sensing device 720.

FIG. 8 includes an illustration of a cross-sectional view of an alternative calibrating system. The radiation-sensing device 800 can be used to measure the intensity of radiation 408 from the pixels 404. Similar to FIG. 7, the radiation-sensing device 800 may be placed in contact with or otherwise adjacent to the user side 320 of the electronic device 700. In this embodiment, the radiation-sensing device 800 may include a radiation-sensing electronic component 864 and a waveguide 820. The edges 822 of the waveguide 820 are adjacent to and extend beyond the edges 406 of the array. In another embodiment, the edges 822 of the waveguide 820 do not extend beyond the edges 406 of the array.

The waveguide 820 can include a material of relatively higher refractive index surrounded by a material of relatively lower refractive index. In one example, a quartz (i.e., silicon dioxide) block having a refractive index of approximately 1.45 may be surrounded by air having a refractive index of approximately 1.0. Alternatively, a block of silicon nitride (refractive index of approximate 2.0), polyethylene napthalate (refractive index in a range of approximately 1.65-1.90), polyimide (refractive index of approximately 1.5-1.7), or other materials could be used. Note that the refractive indices may vary depending on the composition of the material (including crystallinity or lack thereof and the wavelength of radiation. The numbers for refractive indices are given to illustrate the general construction of a waveguide. The radiation-sensing electronic component 864 is connected to one of the edges 822 of the waveguide 820. The waveguide 820 optically couples the pixels 404 to the radiation-sensing electronic component 864. Similar to the system shown in FIG. 7, some or all of pixels 404 within the array may be activated at the same time while their emission intensity is measured by the radiation-sensing electronic component 864.

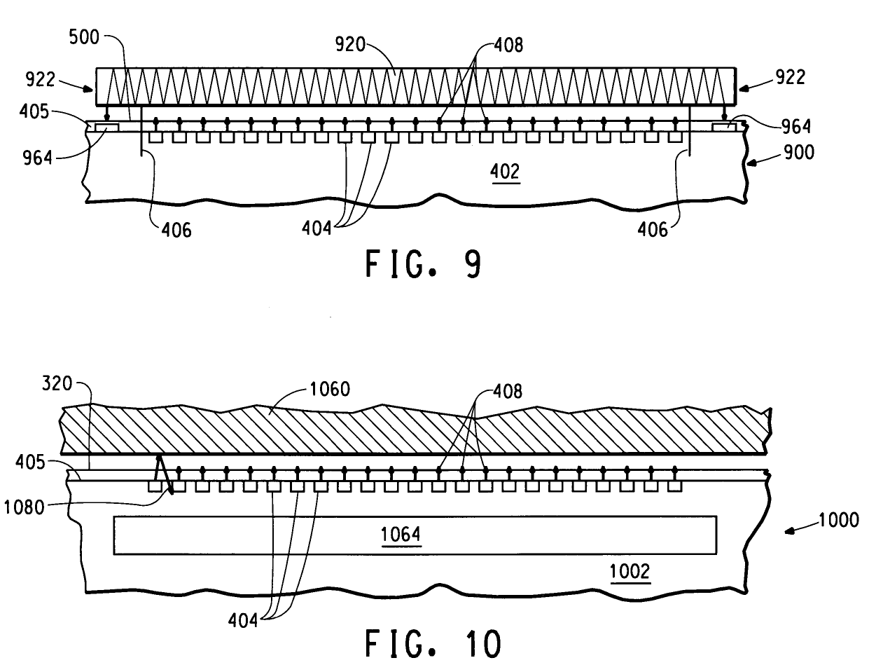

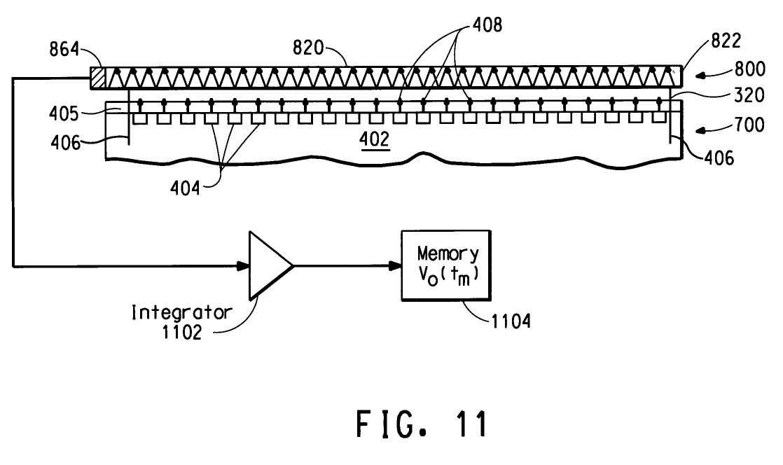

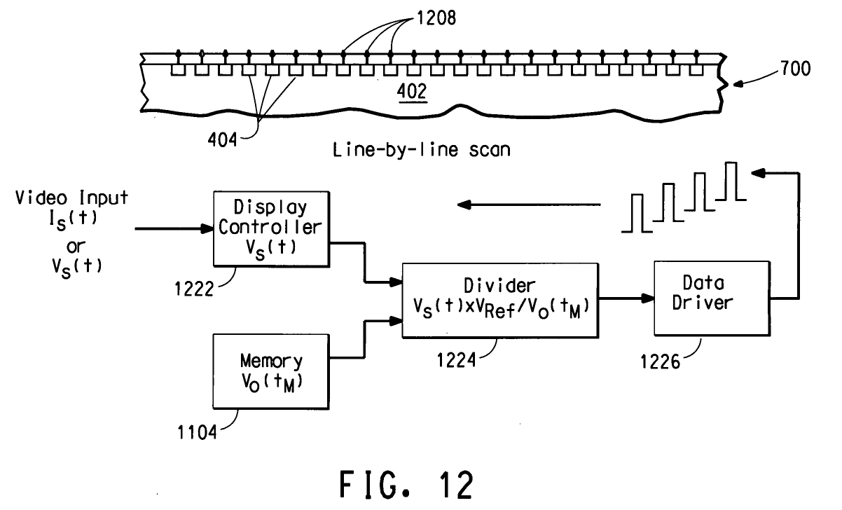

FIG. 9 includes an illustration of one embodiment with a hybrid calibrating system. In this particular embodiment, the electronic device 900 can include pixels 404, radiation-sensing electronic components 964, and a protective shield 402. A waveguide 920 has edges 922 extending at least to the radiation-sensing electronic components 964. The waveguide 920 may be similar to the waveguide 820 in its composition. It may also be used in a similar manner. However, unlike the system shown in FIG. 8, the radiation-sensing electronic components 964 are embedded within the electronic device 900, more specifically in the substrate 405, as opposed to a separate apparatus. During calibration, radiation 408 from pixels 404 may travel along the waveguide 920 until it reaches the radiation-sensing electronic components 964.

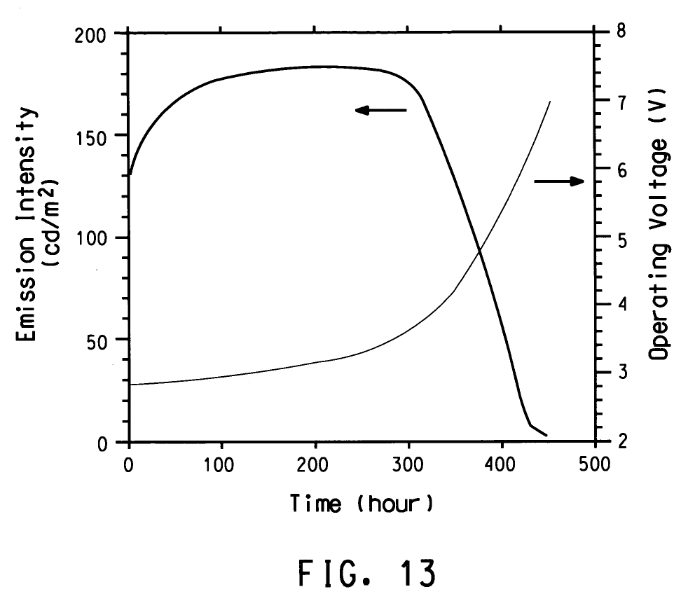

FIG. 10 includes an illustration of one embodiment with yet another hybrid calibrating system. An electronic device 1000 may include a radiation-sensing electronic component 1064 that is buried within a passivation layer or protective shield 1002. During fabrication, the protective shield 1002 may be formed after the pixels 404 have been formed along the substrate 405. During a calibration operation, a reflector 1060 may be placed over the array. Radiation 408 from pixels 404 may be reflected by the reflector 1060 to the radiation-sensing electronic component 1064. The reflected radiation is illustrated by arrow 1080. In yet another alternative embodiment (not shown), a combination of a waveguide and radiation-sensing electronic component(s) similar to those shown in FIGS. 4-6 may be embedded within the protective shield 1002 at location below the array.

Fabrication of the protective shield 1002 is briefly addressed. After forming the pixels 404, a first portion of the protective shield 1002 may be formed over the substrate 405 and pixels 404. The radiation-sensing electronic component 1064 may be formed by plasma-enhanced chemical vapor deposition or physical vapor deposition of a silicon material. The appropriate n-type and p-type doping may be performed in-situ during a portion of the deposition, may be performed subsequent to the deposition, or a combination thereof. An etching operation may be used to pattern the radiation-sensing electronic component 1064. Another layer of the shielding material can be formed over the radiation-sensing electronic component 1064 to complete formation of the protective shield 1002. A user of the electronic device 1000 will see the user side 320.

If a combination of a waveguide and radiation-sensing electronic component(s) are to be formed (not shown in FIG. 10) in place of the radiation-sensing electronic component 1064, the fabrication may be different. After forming the pixels 404, a first portion of the protective shield 1002 may be formed over the substrate 405 and pixels 404. The material for the waveguide may be formed by plasma-enhanced chemical vapor deposition or physical vapor deposition of a silicon nitride material. The silicon nitride material may be subsequently patterned to form the waveguide. The radiation-sensing electronic component may be formed by plasma-enhanced chemical vapor deposition or physical vapor deposition of a silicon material. The appropriate n-type and p-type doping may be performed in-situ during a portion of the deposition, may be performed subsequent to the deposition, or a combination thereof. A polishing operation may be used to remove the silicon material overlying the waveguide. Subsequent patterning may be performed to form the outer side edges of the sensor(s) (edges other than one that contacts the waveguide). Another portion of the protective shield can be formed over the radiation-sensing electronic component(s) and waveguide to complete formation of the protective shield layer. In an alternative method, the radiation-sensing electronic component may be formed before forming the waveguide.

Other fabrication methods or sequences can be performed. For example, the waveguide and radiation-sensing electronic component(s) may be fabricated within a protective shield separate from the pixels 404. The shield with the embedded waveguide and radiation-sensing electronic component(s) may be later attached to the substrate 405. The formation conditions for the waveguide and radiation-sensing electronic component(s) may not be limited to conditions set by materials used within the pixels 404. In still another alternative embodiment, other materials may be used for the waveguide. Some of the materials for waveguides have been previously described.

In another alternative embodiment (not shown), the anode(s), cathode(s), or any combination of anode(s) and cathode(s) of the radiation-emitting elements may be transparent to the radiation emitted from the pixels 404. In this embodiment, a reflector may not be needed, and the radiation-sensing electronic component or radiation-sensing electronic component/waveguide combination may not lie between the pixels 404 and the user side 320 of the electronic device 1000.

In other embodiments (not shown), the radiation-sensing electronic device 720 or radiation-sensing electronic component 1064 may comprise a series of radiation-sensing electronic components oriented in a row, a column, or both row(s) and column(s). In still another alternative electronic device (not shown), each pixel 404 may have its own corresponding radiation-sensing electronic component. One or both electrodes of the radiation-sensing electronic component may be transparent when each pixel includes a radiation-emitting and corresponding radiation-sensing element. As the number of radiation-sensing electronic components increases, the number of circuits and other electrical connections may also increase the complexity or cost of the design. After reading this specification, skilled artisans will be able to determine what radiation-sensing configuration fits their needs or desires.

3. Methods of Using the Electronic Devices During Calibration and Normal Operating Modes

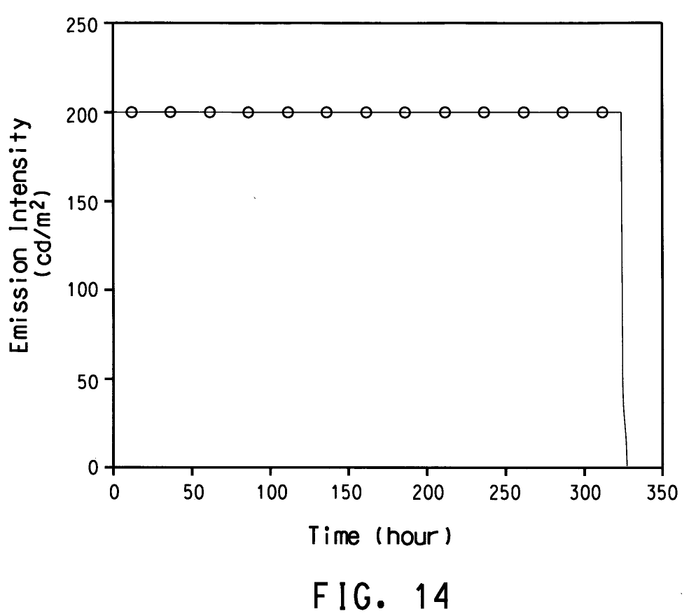

The calibration system as illustrated in FIG. 11 can be used to collect data for calibrating. The electronic device 700 includes a substrate 405 from which pixels 404 are fabricated. In one embodiment, the pixels may be organized into an array having rows and columns of pixels. Each of the pixels 404 includes at least one radiation-emitting electronic component. For a monochromatic display, each pixel may have only one radiation-emitting electronic component. For a full-color display, each pixel may have a red radiation-emitting electronic component, a green radiation-emitting electronic component, and a blue radiation-emitting electronic component. For a monochromatic display, the radiation-sensing device 800 may have only one type of radiation-sensing electronic component. The radiation-sensing electronic component 864 and waveguide 820 have been previously described.

After the electronic device 700 is fabricated, the pixels 404 are turned on to emit radiation 408. In one embodiment, the entire array of pixels 404 is activated. In another embodiment, a portion of the array, such as a row, column, quadrant, or any combination thereof, is activated. The signals that control the pixels 404 are calculated to achieve a desired emission intensity. For an indoor display, the emission intensity may be 200 cd/m². For a full color indoor display, the emission intensities may be 50 cm/m² for red, 100 cd/m² for green, and 50 cd/m² for blue. For an outdoor display, the emission intensities may be 5-10 times greater. In another embodiment, predetermined signal level could be used to activate the pixels 404.

A signal or signals from the radiation-sensing electronic component 864 is sent to a charge integrator or I-V converter, herein “integrator 1102”. In one embodiment, the integrator 1102 can be an operational amplifier or a differential amplifier. If the integrator 1102 is a differential amplifier, it may include another input terminal (not shown) that is connected to a constant voltage. A resistive electronic component may have one terminal connected to an input of the integrator 1102 and another terminal connected to the output of the integrator 1102. The output of the integrator 1102, which in one embodiment is a voltage, can be sent to a memory 1104. In one embodiment, the memory 1104 is a register, a random access memory, a hard drive or the like. The original reading can be stored as V_{ref} and as V₀(t_{M}) in the memory zone 1104. In another embodiment, V_{ref}, V₀(t_{M}), or both are sent to a divider (described with respect to FIG. 12). If the display has more than one type of radiation-emitting electronic component, then the method is repeated for each of the different types of radiation-emitting electronic components. In one embodiment, the array includes red, green, and blue electronic components, therefore, V_{ref-red}, V_{0-red}(t_{M}), V_{ref-green}, V_{0-green}(t_{M}). V_{ref-blue}, and V_{0-blue}(t_{M}) are stored.

During a subsequent calibration, the same control signals for originally achieving V_{ref} are used. The radiation-sensing electronic component 864 receives at least some of the radiation 408 from the pixels 404 similar to the first calibration sequence. An output from radiation-sensing component 864 is received by the integrator 1102. An output from the integrator can be stored as V₀(t_{M}). In an alternative embodiment, V₀(t_{M}) is sent to a divider 1224 (see FIG. 12). However, V_{ref} remains the same. As the radiation-emitting electronic components in pixels 404 degrade or age, the value of V₀(t_{M}) generally decreases with use, age, or both.

FIG. 12 illustrates how the values generated during the calibration can be used to adjust signals going to the display to compensate for degradation or aging of the electronic components within the display. A video input signal is received by a display controller 1222. The video input signal corresponds to an image or other information to be shown at a display of the electronic device 700. In one embodiment, the video input signal can be a current, Iₛ(t). The display controller can convert the current to a voltage, Vₛ(t). In another embodiment, the video input signal can be a voltage, Vₛ(t), and therefore, conversion of the video input signal from a current to a voltage is not required. If the display is a full-color display, more than one video input signal can be received or more than one display controller output can be derived from the video input signal. In this embodiment, V₀(t_{M}) is a calibration value. More than one calibration value can be used. In one embodiment, the number of calibration values is less than the number of pixels 404 within the array.

An output from the display controller is sent to and received by a divider 1224. Divider 1224 may have registers to store V_{ref} and V₀(t_{M}). If not, the divider 1224 accesses or receives the value(s) for V_{ref}, V₀(t_{M}), or both from memory zone 1104 if the divider 1224 does not already have them. In one embodiment, V_{ref}/V₀(t_{M}) is an adjustment factor. More than one adjustment factor can be used. In one embodiment, the number of adjustment factors is less than the number of pixels 404 within the array.

The divider 1224 multiples the output signal from the display controller (e.g., Vₛ(t)) times the adjustment factor (e.g., V_{ref} divided by V₀(t_{M})). In one embodiment, the divider 1224 adjusts the signals to reflect the state of the pixels 404 as of the most recent calibration. The output from the divider 1224 is sent to and received by the data driver 1226. In one embodiment, the data driver 1226 is conventional and operates using line-by-line scanning. If the pixels 404 include red, green, and blue radiation-emitting electronic components, the method can be repeated for each of the different types of radiation-emitting electronic components. Other circuits (e.g., row drivers) can be used to synchronize the signals so that the correct image or other information of proper emission intensity is displayed to the user of the electronic device 700.

Calibration procedures for the other electronic devices can be performed in a similar fashion. In one embodiment as illustrated in FIG. 1, the dummy display 162 can allow for calibration without the use of external equipment or disturbing the image or other information displayed to the user of the electronic device. In another embodiment, the dummy display 162 can use at least some of the same signals as the user display 120. For example, at a first time period, the dummy display 162 uses the same signals as used to drive the first column of pixels within the user display 120, and at a second time, the dummy display 162 uses the same signals as used to drive the second column of pixels within the user display 120, etc. In this manner, the dummy display 162 reflects the average driving conditions of the user display 120.

In still another embodiment, the dummy display 162 may use the same signals as pixels within the array along a diagonal within the user display 120. In yet another embodiment, the dummy display 162 may use the same signals as randomly selected pixels within the user display 120. The randomly selected pixels can be changed periodically. In yet another embodiment, the pixels within the dummy display 162 may be driven by signals that reflect an averaged value (e.g., average, geometric mean, median, etc.) of pixels within the user display 120. For example, the first row of pixel(s) within the dummy display 162 may be driven by signals that reflect averaged values of signals from the first row of pixels within the user display 120. In yet further embodiments, the orientation of the dummy display 162 may have a length corresponding to the length of the user display 120. Many other embodiments are possible, and to list every one would be nearly impossible. After reading the specification, skilled artisans will appreciate that the dummy display 162 can be used to at least partially replicate the degradation and aging conditions of pixels within the user display 120.

4. Software/Hardware/Firmware

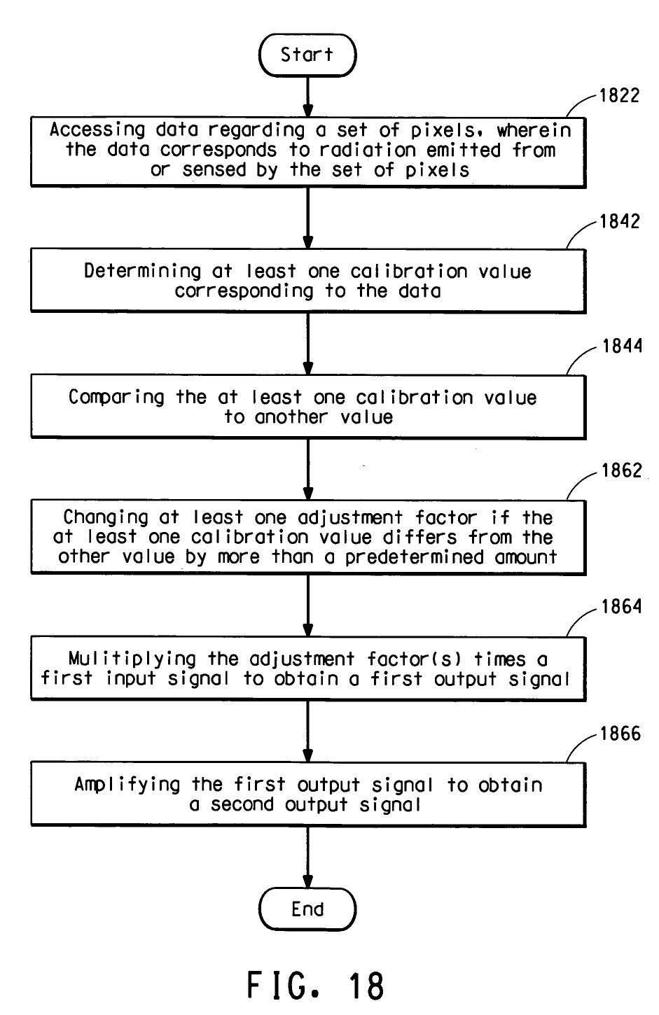

The methodology previously described can be implemented in software, hardware, firmware, or any combination thereof. FIG. 17 includes an illustration of an electronic device 1700 that includes the user display 120, as previously described with respect to FIG. 1. The electronic device 1700 also includes a data processing system 1710 that is bi-directionally coupled to the user display 120, and a radiation-sensing electronic device 1762. In this embodiment, the radiation-sensing electronic device 1762 is physically separate from the electronic device 1700. In one embodiment, the radiation-sensing electronic device 1762 is a digital camera. In another embodiment, the electronic device 1700 includes one or more radiation-sensing components.

The data processing system 1710 includes a central processing unit (“CPU”) 1720 and one or more of a read-only memory (“ROM”) 1722, a random-access memory (“RAM”) 1724, and a synchronizing unit 1726. The synchronizing unit 1726 is used to control the timing of signals that are sent to the display 120 and the radiation-sensing electronic device 1762. The synchronizing unit 1726 may have its own clock (not illustrated) or use the clock (not illustrated) of the data processing system 1710. The synchronizing unit 1726 is conventional and may also be called an event manager. In one embodiment, one or more timers are used to delay a signal sent to the radiation-sensing electronic device 1762 to ensure that the display 120 is on and emitting radiation (illustrated by waving lines 1782) when the radiation 1782 is received by the radiation-sensing electronic device 1762.

The electronic device 1700 also includes one or more input/output ports (“I/O”) 1742. Devices that can be connected to the I/O 1742 can include any one or more of a hard disk (“HD”) 1764, a keyboard, monitor, printer, electronic pointing device (e.g., mouse, trackball, etc.), or the like. In the embodiment illustrated, the I/O 1742 is bi-directionally coupled to the CPU 1720, the synchronizing unit 1726, the radiation-sensing electronic device 1762, and the HD 1764.

Many alternative embodiments are possible. In one embodiment, the display 120 can be replaced by a sensor array that includes a plurality of radiation-sensing components, and the radiation-sensing electronic device 1762 can be replaced by another electronic device that includes one or more radiation sources.

In another embodiment, part or all of the data processing system 1710 may or may not reside outside of the electronic device 1700. For example, the data processing system 1710 can be a personal computer or a server computer. The actual configuration of hardware, software, firmware, or any combination thereof may, in part, depend on the actual electronic device. For example, the electronic device 1700 can include a personal digital assistant, a laptop computer, a pager, a mobile phone (e.g., cellular phone), or the like. Therefore, the electronic device 1700 may or may not include the HD 1764. In still another embodiment, a database (not illustrated) may be connected to the electronic device 1700 via at a port within at I/O 1728, thereby potentially obviating the need for the HD 1764.

After reading this specification, skilled artisans will appreciate that many other configurations are possible and to list every one of them would be nearly impossible. Also, the data processing system 1710 or one of its variants can be used with other display and sensor configurations previously described.

The methods described herein may be implemented in suitable software code that may reside within the ROM 1722, RAM 1724, HD 1764, or any combination thereof. In addition to the types of memories described above, the instructions in an embodiment may be contained on a different data processing system readable storage medium. Alternatively, the instructions may be stored as software code within a storage area network, magnetic tape, floppy diskette, electronic read-only memory, optical storage device, CD ROM, other appropriate data processing system readable medium or storage device, or any combination thereof. The memories described herein can include media that can be read by the CPU 1720. Therefore, each of the memories includes a data processing system readable medium. For the purposes of this specification, firmware is considered a data processing system readable medium.

Portions of the methods described herein may be implemented in suitable software code that includes instructions for carrying out the methods. In one embodiment, the instructions may be lines of source code, object code, or assembly code. In a specific embodiment, the instructions may be lines compiled C⁺⁺, Java, or other language code. The code can be contained within one or more data processing system readable medium.

The functions of the data processing system 1710 may be performed at least in part by another apparatus substantially identical to data processing system 1710 or by a computer, server blade, or the like. Additionally, software with such code may be embodied in more than one data processing system readable medium in more than one data processing system.

Communications within the electronic device 1700 or between the electronic device and other electronic devices, such as the radiation sensing electronic device 1762 can be accomplished using radio frequency, electronic, or optical signals. When a user is at the electronic device 1700, the electronic device 1700 may convert the signals to a human understandable form when sending a communication to the user and may convert input from the user to appropriate signals to be used by the electronic device 1700.

Much of the methodology and its variants have been previously described. FIG. 18 includes a flowchart of one embodiment that can be used. The data processing system 1710 can be programmed to perform the activities within the flow chart via code that can include instructions corresponding to the activities. The code can include an instruction for accessing data regarding a set of pixels, wherein the data corresponds to radiation emitted from or sensed by the set of pixels (block 1822 in FIG. 18).

In one embodiment, the information corresponds to data collected from the set of pixels while the set of pixels are activated. The set of pixels can include all pixels within the display 120 or a subset thereof, such as one or more rows, one or more columns, a quadrant, or the like. Referring to FIG. 17, the synchronizing unit 1726 is configured to send signals to activate the set of pixels within the display 120 (via CPU 1720) and to the radiation-sensing electronic device 1762 to initiate collection of data corresponding to radiation emitted from the set of pixels within the display 120. The synchronizing unit 1726 helps to ensure that activation of the set of pixels and collection of data occur simultaneously during at least one point in time.

In another embodiment, the display 120 is replaced by a sensor array, and the radiation-sensing electronic device 1762 is replaced by one or more radiation sources. In this embodiment, the synchronizing unit 1726 is configured to send signals to activate the radiation source(s) and activate the set of pixels within the sensor array (via CPU 1720). The set of pixels will collect data that corresponds to radiation emitted from the radiation source(s). The synchronizing unit 1726 helps to ensure that activation of the radiation source(s) and activation of set of pixels occur simultaneously during at least one point in time.

Accessing may include obtaining the data as it is collected or retrieving such data from memory (e.g., RAM 1724, HD 1764, database, storage area network, etc.). Therefore, “accessing” should be broadly construed.

The code can also include an instruction for determining at least one calibration value corresponding to the data (block 1842). In one embodiment, the number of the calibration value(s) is less than the number of the pixels within the set. The code can further include an instruction for comparing the calibration value(s) to another value (block 1844)

The code can still further include an instruction for changing at least one adjustment factor if the calibration value(s) differs from the other value by more than a predetermined amount (block 1862). In one embodiment, the number of the adjustment factor(s) is less than the number of the pixels within the set. The code can also include an instruction for multiplying the adjustment factor(s) times a first input signal to obtain a first output signal (block 1864) and an instruction for amplifying the first output signal to obtain a second output signal (block 1866).

5. Other Embodiments

The embodiments described above are well suited for AMOLED displays. Still, the concepts described herein can be used for other types of radiation-emitting electronic components. Other radiation-emitting electronic components can include light bulbs, inorganic LEDs, including III-V or II-VI-based inorganic radiation-emitting components. In one embodiment, the radiation-emitting electronic components may emit radiation within the visible light spectrum, and in another embodiment, the radiation-emitting electronic component may emit radiation outside the visible light spectrum (e.g., UV or IR). The embodiments may also be used for passive matrix displays.

In another embodiment, the concepts described herein may be extended to other types of electronic devices. In one embodiment, a sensor array may include an array of radiation-sensing electronic components. In one embodiment, different radiation-sensing electronic components may have the same or different active materials. The sensitivity of those active materials may change over time. For radiation-sensing electronic components, a radiation source of substantially constant emission intensity (from calibration to calibration) can be used to irradiate the pixels 404, each of which includes one or more radiation sensing electronic components. Electronic signals generated by the pixels 404 would be sent to the integrator 1102. In normal (sensing) operation, adjustment factors can be used by sense amplifiers or other circuits to compensate for the degradation or aging of the electronic components. Similar to an electronic device with radiation-emitting electronic components, an electronic device with radiation-sensitive electronic components may have a longer useful life.

Although not shown, a radiation-sensing electronic component can be also put directly on top of a display (user display or dummy display). In this embodiment, a reflector or waveguide may not be needed.

In still another embodiment, the electronic device can include radiation-emitting and radiation-sensing components within the same array.

Portions or all of the methods described herein can be implemented in hardware, software, firmware, or any combination thereof. For software, instructions corresponding to the method can be lines of assembly code or compiled C⁺⁺, Java, or other language code. The code may reside on a data processing readable medium, a hard disk, magnetic tape, floppy diskette, optical storage device, networked storage device(s), random access memory, or other appropriate data processing system readable medium or storage device. The data processing system readable medium may be read by a data processing system, such as a computer, microprocessor, microcontroller, or the like.

6. Advantages

One or more embodiments described herein can be used to help to extend the useful life of electronic devices. The calibration techniques generate as little as one calibration value for the entire array or for any portion thereof. Because calibration data is not being collected on a pixel-by-pixel basis, the calibration procedure can be performed more quickly and does not need as much memory. Similarly, as little as one adjustment factor may be used for the entire array or for any portion thereof. Because adjustment factor(s) are not applied on a pixel-by-pixel basis, not as much memory is needed. The calibration and normal (e.g., display) modes may be performed faster and at lower power (due to less data being stored and retrieved).

In a full-color display, every pixel contains three sub-pixels emitting red, green or blue colors respectively. The three-color subpixel sets could have different aging mechanisms or different aging rates. The calibration procedure above could be extended into the three primary color emitter sets. When the intensities of sub-pixels within the emitter set are calibrated, the white color balance of the full-color display is also maintained.

In one embodiment, the calibration methods can be implemented in hardware, software, firmware, or any combination thereof and does not change the substrate used for the user display 120. In another embodiment, radiation-sensing electronic components can be added to the substrate or protective shield without changing the substrate used for the user display 120.

In still another embodiment, a dummy display 162 can be used that may or may not lie within the viewing area 122 of the electronic device. In one specific embodiment, the dummy display 162 lies outside the viewing area 122 of the electronic device. The use of the dummy display 162 is not significantly perceived by the user because a housing or other portion of the electronic device lies between the dummy display 162 and user. A calibration procedure can be performed at nearly any time and even when the user display 120 is in use (displaying an image or other information to a user of the electronic device) because the dummy display lies outside the viewing area 122.

### EXAMPLES

The following specific examples are meant to illustrate and not limit the scope of the invention.

### Example 1

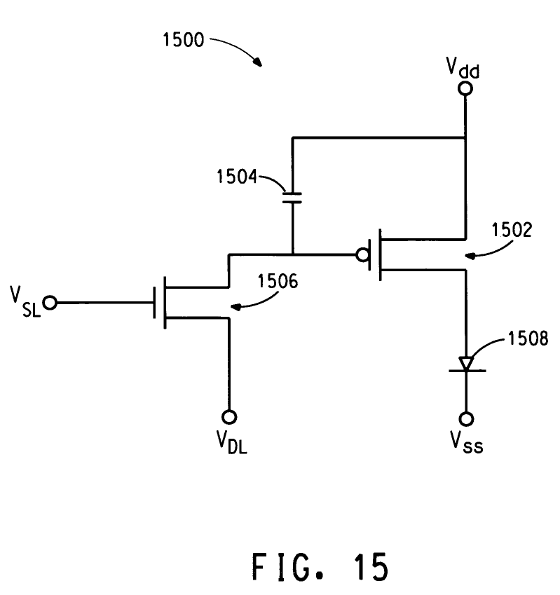

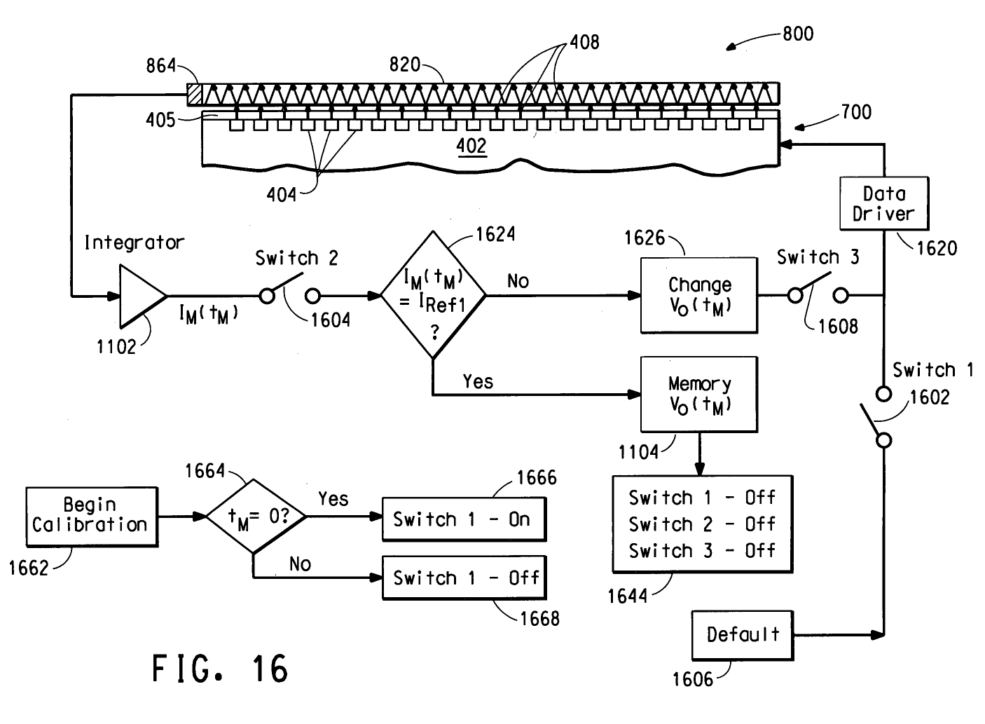

Example 1 illustrates that the compensation devices and methods can be used to achieve more constant emission intensity during the lifetime of radiation-emitting electronic components. Two OLEDs comprising polymer active layers are fabricated using conventional procedures. Glass/ITO is used as substrate and transparent anode. A thin layer of polyaniline or poly(3,4-ethylendioxythiophene) (“PEDOT”) is deposited over the glass/ITO. A polyfluorene-based organic active layer is then deposited over the thin layer of polyaniline or PEDOT. A thin layer of metal Ba/Al is vacuum deposited over top of polyfluorene organic layer and serves as a cathode. The color of radiation emitted from the electronic devices depends on the opto-electronic properties of the material(s) within the organic active layer. One electronic device is operated using a conventional driving scheme, i.e. constant current at approximately 7 mA. The other electronic device is operated using a compensation driving scheme, such as one discussed above to keep the emission intensity constant. FIG. 13 illustrates that under the conventional driving scheme, the emission intensity fluctuates by as much as approximately 50% during its usable lifetime. FIG. 14 illustrates that under one of the compensation driving schemes, the emission intensity of the electronic device has an inhomogeneity of less than 0.4% over its operation lifetime.

### Example 2

Example 2 demonstrates that the methods disclosed herein do not only compensate the electronic component aging, but also compensate the maximum intensity variation caused by other sources, such as from aging of electronic components within pixel driver circuits. Example 2 also illustrates that the configuration as illustrated in FIG. 8 can be used to measure radiation intensity for a 10×10 matrix OLED display. In one embodiment, the matrix is an active matrix, and in another embodiment, the matrix is a passive matrix.

FIG. 15 includes a circuit diagram of an electronic device 1500 that includes a power transistor 1502, a capacitive electronic component 1504, a switch 1506, and an organic electronic component 1508. The organic electronic component 1508 may be a radiation-emitting electronic component, a radiation-sensing electronic component, or the like. In one embodiment, the electronic device 1500 includes an array of the circuits as illustrated in FIG. 15. Each of the other organic electronic components within the array is substantially identical to the organic electronic component 1508. Also, the circuitry used with each organic electronic component is substantially identical to that shown in FIG. 15. A signal from the data driver 1226 (as illustrated in FIG. 12) is sent over a data line and is received by the circuit as illustrated in FIG. 15 as V_{DL}. When a select signal, V_{SL}, is received by the switch 1506, the V_{DL} signal is transmitted to and received by the capacitive electronic component 1504 and the control electrode (e.g., gate electrode) of the power transistor 1502.

In one embodiment, the power transistor 1502 is a p-channel metal-insulator-semiconductor field-effect transistor (“MISFET”), and the switch 1506 is an n-channel MISFET. In an alternative embodiment, the power transistor 1502 may be nearly any other type of transistor including an n-channel MISFET, a junction field-effect transistor, a bipolar transistor or the like. For a field-effect transistor, the field-effect transistor can be n-channel, p-channel, enhancement mode or depletion mode. For a bipolar transistor, the bipolar transistor may be pnp or npn. Switch 1506 may include any one or more of the transistors previously described, one or more diodes, a mechanical switch, an electromechanical switch, or any combination thereof.

In one embodiment, an active matrix or passive matrix display may be used. The emission intensity can be defined generally by
L=C₁+C₂*V_{DL}+C₃*V_{DL}²+C₄*V_{DL}³+ Equation 1

where L is the emission intensity, V_{DL} is the data voltage output from data driver (e.g., on a data line) into display columns, and C₁ through Cₓ (x=2, 3, 4 . . . ) are constants. For example, for an active matrix display with the two TFT (thin-film transistor) pixel design as shown in FIG. 15 (wherein a select signal, V_{SL}, is the control voltage of the switch 1506, V_{dd} is the anode voltage, Vₛₛ is the cathode voltage, and V_{DL} is the data voltage output from the data driver (i.e., voltage on the data line)), if Vₛₛ is smaller than the value of the required saturation voltage of the power transistor 1502 minus the voltage drop on the radiation-emitting electronic component, emission intensity can be expressed as
L=a*(b−V_{datags})² Equation 2

where V_{datags} (V_{DL}−V_{dd}) is the voltage between gate and source of the power transistor 1502, and a and b are constants which depend on the mobility of charge carriers within the channel region, channel length, channel width, insulator capacitance between gate and channel, other physical or electrical characteristics of the power transistor 1502, or any combination thereof. In one embodiment, V_{dd} is approximately 0 volts, and therefore, V_{datags}=V_{DL}.

From Equation 2, only two parameters (a and b) need to be determined from calibration. If two sets of data (L₁ and V_{1datags} (or V_{DL1}), and L₂ and V_{2datags} (or V_{DL2})) are measured or otherwise collected during calibration, a and b parameters can be calculated. In one embodiment, 8-bit data input is used, and therefore, 256 gray levels can be achieved. In this embodiment, a radiation sensor collects 256 L values from L_{gl1} to L_{gl256} and records them into memory 1104. For certain input data (video), corresponding calibrated L for the gray level of the pixel can be retrieved from memory 1104, and V_{DL} can be determined from Equation 2 and sent by the data driver 1226.

In one embodiment, a sensing mode is used during a calibration sequence. I_{Ref} is the current used for the targeted emission intensity for the display panel. To achieve a substantially constant display intensity at the targeted emission intensity over time, emission intensity calibration is performed and variable V₀(t_{M}) is obtained. In sensing mode, the voltage variation V₀(t_{M}) is recorded into the memory zone in a display controller.

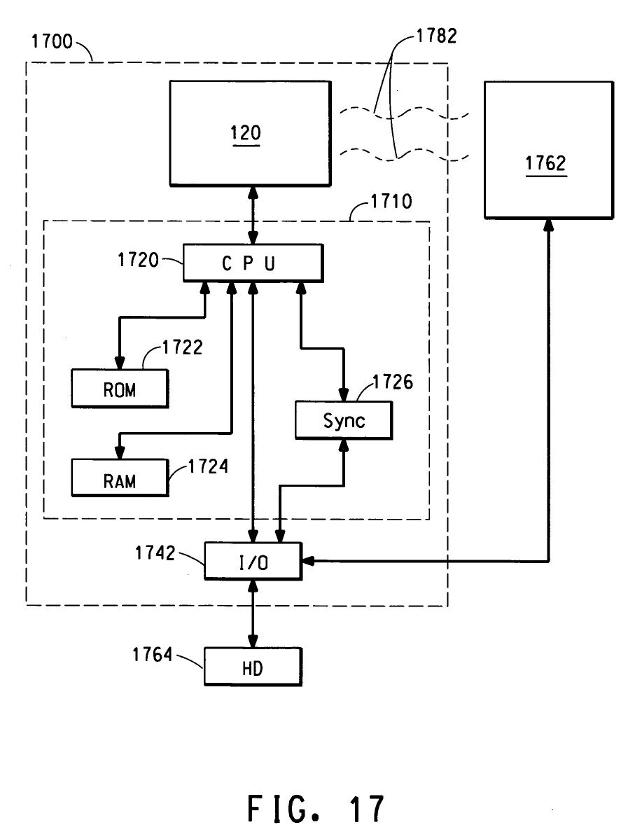

More specifically, FIG. 16 includes an illustration of the calibrating system 800 illustrated in FIG. 8 in combination with a partial flow diagram during a calibrating operation of the electronic device 700.

The flow chart in FIG. 16 is similar, but includes more details as compared to FIG. 11. Initially, the switches 1602 and 1604 are closed. Switch 1604 will remain closed during the calibration operation. A default calibrating voltage (V_{C}) 1606 can be supplied through the switch 1602 to the data driver 1620. The data driver 1620 can send one or more signals to the pixels 404 within the array. As the pixels 404 are activated, radiation 408 is emitted from the pixels 404, and at least part of the radiation is sent along waveguide 820 to a radiation-sensing electronic component 864. The signal from the radiation-sensing electronic component 864 can then be sent to and received by the integrator 1102. In this example, I_{M}(t_{M}) is the output signal from the integrator 1102. The signal passes through the switch 1604 and a decision is made whether I_{M}(t_{M}) is within tolerance. In one embodiment, I_{M}(t_{M}) may need to be a reference current, I_{ref}, plus or minus a predetermined value (e.g., I_{ref}+/−4%). If not, the output signal for the pixels 404 is not within the range (“no” branch of diamond 1624). Switch 1602 is opened, and switch 1608 is closed. The voltage signal to the data driver 1620 is changed to a new V₀(t_{M}) (block 1626). The data driver 1620 uses the new V₀(t_{M}) to increase or decrease the emission intensity. The loop is iterated until I_{M}(t_{M}) is within tolerance. When I_{M}(t_{M}) is within tolerance (“yes” branch of diamond 1624), the latest value of V₀(t_{M}) is stored within memory 1104. Switches 1608 and 1604 may then be opened and the first calibration cycle ends (block 1644).

When a calibration sequence begins (block 1662), a determination is made whether the calibration sequence is the first one (t_{M}=0) (diamond 1664). If yes, switch 1602 is closed (“on”) (block 1666). For subsequent calibration sequences (“no” branch from diamond 1664), switch 1602 is open (“off”) (block 1668). The subsequent calibrations are performed substantially as described except that values from memory 1104, rather than default values 1606, are used at the beginning of the calibration sequence.

The logic and other operations described with respect to FIG. 16 may be performed by circuitry within the electronic device 700, within a separate apparatus used for the calibration system, a remote computer (not shown), or a combination thereof. After reading this specification, skilled artisans appreciate that this is just one of several potential calibrating operations that can be used with the electronic devices as described. Clearly, other calibrating operations are contemplated and may be used. One of ordinary skill in the art will appreciate that the level of homogeneity in the display can be made higher or lower simply by modifying the tolerance on the reference voltage.

During a display mode, the method is substantially the same as described with respect to FIG. 12. In one embodiment, a signal from the data driver 1226 (as illustrated in FIG. 12) is sent over a data line and is received by the circuit as illustrated in FIG. 15 as V_{DL}. When a select signal, V_{SL}, is received by the switch 1506, the V_{DL} signal is transmitted to and received by the capacitive electronic component 1504 and control electrode (e.g., gate electrode) of the power transistor 1502.

In one embodiment, a photodiode is mounted on front of a 9″ (nominal) AMOLED panel. The ambient light intensity can be determined to ensure that it is at or below an acceptable level for calibration purposes. Stable maximum display intensity can be achieved throughout the lifetime of the electronic device, even as radiation-emitting and other electronic components are used or age.

### Example 3

Example 3 demonstrates that the compensation scheme and apparatus disclosed in FIGS. 1 and 2 are practical for AMOLED displays and provide stable maximum emission intensity. The electronic device in this example includes a 4″ (nominal) AMOLED user display with a QVGA format (320×RGB×240 pixels). The electronic device also includes 10×RGB columns on each side of the display as dummy displays. The dummy displays are operated with the same data signal as the center portion of the user display. The maximum emission intensity of the dummy displays are measured during predetermined periods, and the variation is used to adjust the emission intensity of both the dummy and user displays. Stable maximum emission intensities can be achieved in both dummy and user displays.

### Example 4

Example 4 demonstrates that the OLED displays with intensity compensation mechanisms disclosed herein can be used for different light intensities pre-set by a user and can be varied at any time. This example is similar to Example 3 except that V_{ref} is varied manually to reflect the emission intensity adjustment different user of a display may desire. The maximum emission intensity keeps the setting value before a new V_{ref} is set. For example, using the embodiment in FIG. 1 or 2, a user may set the OLED display to 300 cd/m², and the dummy display will be calibrated automatically, and the required V_{ref} will be determined. Then as shown in FIG. 12, the voltage (=Vₛ(t)×V_{ref}/V₀(tₘ)) from divider 1224 will be sent to the user display through data driver 1226.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A electronic device comprising:
a set of pixels that each include one or more radiation-emitting components, one or more radiation-sensing components, or any combination thereof; and
a data processing system that is configured to:
access data regarding the set of pixels, wherein the data corresponds to radiation emitted from or sensed by the set of pixels;
determine at least one calibration value corresponding to the data, wherein a number of the at least one calibration value is less than a number of the pixels within the set;
compare the at least one calibration value to another value; and
change at least one adjustment factor if the at least one calibration value differs from the another value by more than a predetermined amount, wherein a number of the at least one adjustment factor is less than the number of the pixels within the set.

2. The electronic device of claim 1, wherein:
the set of pixels includes the one or more radiation-emitting components;
the data processing system comprises a synchronizing unit that controls timing of signals;
the signals are used to activate the set of pixels and initiate collection of data corresponding to radiation emitted from the set of pixels; and
the synchronizing unit is configured such that activation of the set of pixels and collection of the data occur simultaneously during at least one point in time.

3. An electronic device, wherein:
the electronic device of claim 2 further comprises
a second electronic device is configured to collect the data and be coupled to the electronic device of claim 2; and
the second electronic device is physically separate from the electronic device of claim 2.

4. The electronic device of claim 3, further comprising at least one radiation-sensing component, wherein the at least one radiation-sensing component is configured to collect the data.

5. The electronic device of claim 1, wherein:
the set of pixels includes the one or more radiation-sensing components;
the data processing system comprises a synchronizing unit that controls timing of signals;
the signals are used to initiate activation of a radiation source and activate the set of pixels during collecting of the data, which corresponds to radiation emitted from the radiation source; and
the synchronizing unit is configured such that activation of the radiation source and activation of the set of pixels occur simultaneously during at least one point in time.

6. The electronic device of claim 5, wherein:
a second electronic device comprises the radiation source; and
the second electronic device is physically separate from the electronic device.

7. The electronic device of claim 5, further comprising the radiation source.

8. An electronic device comprising:
a dummy display of first radiation-emitting electronic components; and
a user display of second radiation-emitting electronic components.

9. The electronic device of claim 8, wherein:
the dummy display is organized into a vector of the first radiation-emitting electronic components; and
the user display is organized into a matrix of the second radiation-emitting electronic components.

10. The electronic device of claim 8, wherein:
the dummy display is organized into a matrix of the first radiation-emitting electronic components; and
the user display is organized into a matrix of the second radiation-emitting electronic components.

11. The electronic device of claim 8, wherein the dummy display lies outside the viewing field of the electronic device.

12. The electronic device of claim 8, further comprising a radiation-sensing electronic component optically coupled to the dummy display.

13. The electronic device of claim 12, wherein the radiation-sensing electronic component is part of a calibration circuit.

14. The electronic device of claim 8, wherein the radiation-emitting electronic components within the dummy display comprise at least one organic active layer.

15. A data processing system readable medium having code for using an electronic device comprising a set of pixels that each include one or more radiation-emitting electronic components, one or more radiation-sensing electronic components, or any combination thereof, wherein the code is embodied within the data processing system readable medium, the code comprising:
an instruction for accessing data regarding the set of pixels, wherein the data corresponds to radiation emitted from or sensed by the set of pixels;
an instruction for determining at least one calibration value corresponding to the data, wherein a number of the at least one calibration value is less than a number of the pixels within the set;
an instruction for comparing the at least one calibration value to another value; and
an instruction for changing at least one adjustment factor if the at least one calibration value differs from the another value by more than a predetermined amount, wherein a number of the at least one adjustment factor is less than the number of the pixels within the set.

16. The data processing system readable medium of claim 15, wherein the another value is a prior calibration value.

17. The data processing system readable medium of claim 15, wherein the code further comprises an instruction for multiplying the at least one adjustment factor times a first input signal to obtain a first output signal.

18. The data processing system readable medium of claim 17, wherein the code further comprises an instruction for amplifying the first output signal to obtain a second output signal.

19. The data processing system readable medium of claim 15, wherein the set of pixels includes a row or a column of pixels within a user display.

20. The data processing system readable medium of claim 15, wherein the set of pixels includes all pixels within a user display.

21. The data processing system readable medium of claim 15, wherein the set of pixels includes all pixels within a dummy display.

22. The electronic device comprising the data processing system readable medium of claim 15.

23. A method of using an electronic device that includes a set of pixels that each include one or more radiation-emitting electronic components, one or more radiation-sensing electronic components, or any combination thereof, wherein the method comprises:
if the set of pixels includes radiation-emitting components:
activating the set of pixels; and
collecting data corresponding to radiation emitted from the set of pixels, wherein activating the set of pixels and collecting data occur simultaneously during at least one point in time;
if the set of pixels includes radiation-sensing components:
activating a radiation source; and
collecting data using the set of pixels, wherein the set of pixels sense radiation corresponding to the radiation emitted from the radiation source, wherein activating the radiation source and activating the set of pixels occur simultaneously during at least one point in time;
determining at least one calibration value corresponding to the collected data, wherein a number of the at least one calibration value is less than a number of the pixels within the set;
comparing the at least one calibration value to another value; and
changing at least one adjustment factor if the at least one calibration value differs from the another value by more than a predetermined amount, wherein a number of the at least one adjustment factor is less than the number of the pixels within the set.

24. The method of claim 23, wherein the another value is a prior calibration value.

25. The method of claim 23, wherein activating a set of pixels includes activating a row or a column of pixels within a user display.

26. The method of claim 23, wherein activating a set of pixels includes activating all pixels within a user display.

27. The method of claim 23, wherein activating a set of pixels includes activating all pixels within a dummy display.

28. The method of claim 23, wherein the radiation-emitting electronic components, radiation-sensing electronic components, or combinations thereof, comprise at least one organic active layer.
